(19) United States
(12) Patent Application Publication
(10) Pub. No.: US 2026/0368329 A1
(43) Pub. Date: Nov. 19, 2026

(54) SYSTEM AND METHOD FOR SYNCHRONIZING BOOTSTRAPPING AND DEPTH MANAGEMENT IN HOMOMORPHIC ATTENTION-BASED ARCHITECTURES

(71) Applicant: Chain Reaction, Ltd., Tel Aviv (IL)

(72) Inventors: Oren VRUBEL, Tel Aviv (IL); Nimrod BORER, Atlit (IL)

(73) Assignee: Chain Reaction, Ltd., Tel Aviv (IL)

(21) Appl. No.: 19/206,764

(22) Filed: May 13, 2025

(51) Int. Cl. G06F 21/57; G06F 9/4401; H04L 9/00; H04L 9/30

(52) U.S. Cl. CPC G06F 21/575; G06F 9/4401; H04L 9/008; H04L 9/3093; G06F 2221/034

(57) ABSTRACT

A method and system for managing bootstrapping in an encrypted attention-based architecture is presented. The method includes receiving encrypted data at a first Residue Number System (RNS) level; applying bootstrapping to adjust a ciphertext from the first RNS level to a second RNS level; multiplying a first portion of the encrypted data to generate an expanded dataset; applying a polynomial-approximation-based function to the expanded dataset; multiplying scaled attention weights by a second portion of the encrypted data at the first RNS level; and generating an encrypted output.

### TECHNICAL FIELD

The present disclosure relates generally to privacy-enhanced machine learning systems and, more specifically, to systems and methods for synchronizing bootstrapping and depth management in homomorphic attention-based architectures.

### BACKGROUND

Machine learning (ML) systems have traditionally operated on unencrypted data, allowing for relatively straightforward training and inference. However, in many applications, such as healthcare, finance, and other privacy-sensitive domains, there is a need to process data without exposing its contents. Fully homomorphic encryption (FHE) has emerged as one solution, enabling computations to be carried out on encrypted data. One well-known FHE scheme is Cheon-Kim-Kim-Song (CKKS), which uses a Residue Number System (RNS) representation to handle the large ciphertext moduli required for homomorphic operations. Despite its practical advantages, running ML workloads under CKKS poses challenges related to noise accumulation, frequent data expansions and reductions, large bit-length representation of operands, and computational overhead including bootstrapping.

When implementing ML under FHE, each encrypted operation accumulates noise, requiring repeated rescaling and eventually bootstrapping to keep the ciphertext usable. Bootstrapping itself is resource-intensive and involves “raising” ciphertexts back to higher RNS levels, among other sub-stages (e.g. C2S, SineEval, and S2C). Many ML models, such as convolutional neural networks (CNNs) or transformer-based large language models, employ multiple layers, each containing linear operations (e.g., convolutions, matrix multiplications) and polynomial approximations of non-linear functions (e.g., ReLU or SoftMax). In an encrypted setting, standard activation functions are replaced by polynomial approximations, which substantially increase the multiplicative depth of these computations, making noise management and strategic bootstrapping critical.

Existing implementations of FHE-based ML rely on basic triggers for bootstrapping, such as a noise threshold, which can lead to repeated or untimely bootstrapping that imposes significant computational and memory overhead. Moreover, expansions in data dimensions within some layers or sub-blocks (for example, attention blocks) may increase these overheads, driving up ciphertext sizes and bandwidth usage. As neural network architectures become more complex, balancing the demands of large-scale linear operations, polynomial approximations of non-linear functions, and frequent ciphertext refresh events remains a challenging task in fully homomorphic environments.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later.

In some embodiments, the disclosed methods and systems analyze the multiplicative depth, the computational loads, data expansion points, and overall performance requirements offline. The techniques disclosed herein select from multiple base bootstrapping configurations, each associated with a distinct computational cost and post-bootstrap residual capacity, and, for any chosen configuration, can further apply partial bootstrapping or capacity borrowing as needed. A final schedule may be chosen to maximize overall performance by balancing the number of bootstraps, the computational load (width), the required multiplicative depth, and the data expansion points throughout the layer.

Embodiments of the present disclosure may be provided as a network of communicating devices (i.e. a “computerized network”). Embodiments of the invention may be also provided as a software application downloadable into a computer device to facilitate the method. The software application may be a computer program product, which may be stored on a non-transitory computer-readable medium on a tangible data-storage device (such as a storage device of a server, or one within a user device).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, computer - implemented method may include receiving encrypted data at a first Residue Number System (RNS) level. Computer - implemented method may also include applying bootstrapping to adjust a ciphertext from the first RNS level to a second RNS level. The method may furthermore include multiplying a first portion of the encrypted data to generate an expanded dataset. The method may in addition include applying a polynomial-approximation-based function to the expanded dataset. The method may moreover include multiplying scaled attention weights by a second portion of the encrypted data at the first RNS level. The method may also include generating an encrypted output. Other embodiments of this aspect include corresponding computer systems, apparatus, and computer programs recorded on one or more computer storage devices, each configured to perform the actions of the methods.

Implementations may include one or more of the following features. The method may include repeating the steps of multiplying the first portion of the encrypted data and applying the polynomial-approximation-based function for each attention head of a plurality of attention heads in a multi-head attention architecture. The method where the multiplication of the first portion of the encrypted data is a shallow-wide operation, the polynomial-approximation-based function is a deep-narrow operation, and the multiplication of scaled attention weights by the second portion of the encrypted data is a shallow-wide operation. The method may include providing the encrypted output as updated token embeddings to at least one subsequent transformer layer or feed-forward block. Implementations of the described techniques may include hardware, a method or process, or a computer tangible medium.

In one general aspect, a non-transitory computer-readable medium may include one or more instructions that, when executed by one or more processors of a device, cause the device to: receive encrypted data at a first Residue Number System (RNS) level; apply bootstrapping to adjust a ciphertext from the first RNS level to a second RNS level; multiply a first portion of the encrypted data to generate an expanded dataset; apply a polynomial-approximation-based function to the expanded dataset; multiply scaled attention weights by a second portion of the encrypted data at the first RNS level; and generate an encrypted output. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to:. The system may furthermore receive encrypted data at a first Residue Number System (RNS) level. The system may in addition apply bootstrapping to adjust a ciphertext from the first RNS level to a second RNS level. The system may moreover multiply a first portion of the encrypted data to generate an expanded dataset. The system may also apply a polynomial-approximation-based function to the expanded dataset. The system may furthermore multiply scaled attention weights by a second portion of the encrypted data at the first RNS level. The system may in addition generate an encrypted output. Other embodiments of this aspect include corresponding computer systems, apparatus, and computer programs recorded on one or more computer storage devices, each configured to perform the actions of the methods.

Implementations may include one or more of the following features. The system where the first portion of the encrypted data may include a plurality of query and key matrices of an attention block. The system where the memory contains further instructions which when executed by the processing circuitry further configure the system to: repeat the steps of multiplying the first portion of the encrypted data and applying the polynomial-approximation-based function for each attention head of a plurality of attention heads in a multi-head attention architecture. The system where the memory contains further instructions which when executed by the processing circuitry further configure the system to: schedule of the bootstrapping based on an offline or compile-time process that balances capacity, noise, and data movement constraints. The system where the multiplication of the first portion produces an expanded dataset from one dimension to a larger dimension on a per attention head basis. The system where the multiplication of the first portion of the encrypted data is a shallow-wide operation, the polynomial-approximation-based function is a deep-narrow operation, and the multiplication of scaled attention weights by the second portion of the encrypted data is a shallow-wide operation. The system where the memory contains further instructions which when executed by the processing circuitry further configure the system to: provide the encrypted output as updated token embeddings to at least one subsequent transformer layer or feed-forward block. Implementations of the described techniques may include hardware, a method or process, or a computer tangible medium.

In one general aspect, system may include The system of claim 12. Other embodiments of this aspect include corresponding computer systems, apparatus, and computer programs recorded on one or more computer storage devices, each configured to perform the actions of the methods.

In one general aspect, system may include The system of claim 12. Other embodiments of this aspect include corresponding computer systems, apparatus, and computer programs recorded on one or more computer storage devices, each configured to perform the actions of the methods.

In one general aspect, system may include The system of claim 12. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction the accompanying drawings.

In the drawings:

FIG. 1 is a flowchart illustrating a method for managing RNS levels and bootstrapping in an encrypted machine learning environment, in accordance with an embodiment of the present disclosure.

FIG. 2 is a conceptual diagram illustrating RNS levels and bootstrapping considerations in an encrypted machine learning environment, in accordance with an embodiment of the present disclosure.

FIG. 3 is a conceptual diagram comparing multiple bootstrapping sequences, in accordance with an embodiment of the present disclosure.

FIG. 4 is a flowchart illustrating a method for managing RNS levels and bootstrapping in a neural network layer, in accordance with an embodiment of the present disclosure.

FIG. 5 is a flowchart illustrating a method for managing RNS levels and bootstrapping in an attention-based architecture, in accordance with an embodiment of the present disclosure.

FIG. 6 is a block diagram of a server incorporating a fully homomorphic encryption (FHE) accelerator, in accordance with various embodiments of the present disclosure.

### DETAILEDDESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

As used herein, the term “Fully Homomorphic Encryption (FHE)” refers to a cryptographic scheme that allows computations to be performed directly on encrypted data without requiring decryption at any intermediate stage. When the resulting ciphertext is eventually decrypted, the outcome matches the result that would have been obtained if the operations had been performed on unencrypted data. FHE may be implemented using various schemes, including but not limited to Cheon-Kim-Kim-Song (CKKS), Brakerski-Fan-Vercauteren (BFV), and Brakerski-Gentry-Vaikuntanathan (BGV), enabling secure processing in privacy-sensitive domains.

As used herein, the term “Residue Number System (RNS) level” refers to a representation of the “height” of the modulus space in an FHE scheme. A higher RNS level indicates a larger modulus and thus supports more sequential homomorphic operations (multiplicative depth) before noise saturates. A lower RNS level reduces ciphertext size and computational overhead but limits the available depth for further operations.

As used herein, the term “bootstrapping” refers to the process of refreshing a ciphertext to a higher RNS level and/or resetting its noise within an FHE scheme. This procedure typically involves a series of sub-steps, such as modulus raising, Coefficients-to-Slots (C2S), polynomial or sine-evaluation, and Slots-to-Coefficients (S2C). Bootstrapping enables FHE systems to overcome noise accumulation and continue homomorphic computations without decryption.

As used herein, the term “residual capacity” refers to the number of usable RNS levels that remain available for computation after a bootstrapping event has completed. For example, each homomorphic multiplication typically consumes one or more levels, so maintaining sufficient residual capacity ensures that subsequent computations can proceed without prematurely initiating another bootstrapping cycle.

As used herein, the term “deep-narrow operation” refers to a computation that involves a higher multiplicative depth (i.e., multiple sequential multiplications) but fewer inter-operand operations at each stage. Non-linear activations in neural networks (e.g., a polynomial approximation of ReLU or SoftMax) typically exemplify deep-narrow operations because they rely on multiple sequential multiplications with limited inter operands operations instead of broad concurrency of operations. Notably, “narrow” does not exclude data expansions or reductions and reflects a deeper chain of multiplications per operand.

As used herein, the term “shallow-wide operation” refers to a computation that involves fewer sequential multiplications (i.e., minimal multiplicative depth) but many multiplications per operand and between operands. Examples include matrix multiplications or convolutions over extensive feature maps, where the primary cost is computational cost and data movement rather than depth-consuming polynomial calculations.

As used herein, the term “mod-raise” refers to the step of raising a ciphertext’s modulus from a lower RNS level to a higher one, as part of bootstrapping. Performing a mod-raise replenishes the capacity to handle further multiplications by expanding the ciphertext’s available residue bases.

As used herein, the term “partial bootstrapping” refers to a bootstrapping approach in which the ciphertext is refreshed to an RNS level sufficient for the next set of operations but lower than the maximum level the scheme supports. This reduces computational overhead when the subsequent computations do not require the highest available multiplicative depth.

As used herein, the term “capacity borrowing” (also called “bootstrapped capacity borrowing”) refers to shifting one or more sub-steps of bootstrapping (e.g., the Slots-to-Coefficients, or S2C, step) to an earlier or later cycle. This selective reordering of sub-steps effectively “borrows” additional RNS levels for the next set of operations, granting extra multiplicative depth when needed for high-complexity computations.

As used herein, the term “machine-learning layer” refers to a discrete architectural block in a neural network or other ML model, such as a convolutional layer, an attention block, or a fully connected layer. A single machine-learning layer can contain multiple operations (e.g., linear transformations, polynomial approximations, average pooling) that are planned or optimized according to the homomorphic encryption constraints described herein. Similar optimizations can be applied to multiple layers in sequence, enabling synchronized bootstrapping strategies across an entire ML model.

The technical problems addressed by the disclosed subject matter involve coordinating the bootstrapping process in fully homomorphic encryption (FHE) computations, including the synchronized scheduling of bootstrapping for each common layer structure in a machine learning (ML) model. As used herein, a “common layer structure” refers to any repeated or substantially similar layer (or sub-block) that shares computational characteristics. Selecting bootstrapping points for each common layer structure, and applying the same or adapted schedule across layers that share identical or similar computational characteristics, can have a cascading effect on performance and resource usage. Specifically, there is a need to address the high computational costs associated with deep-narrow operations (which have greater multiplicative depth) and shallow-wide operations (which have larger computational effort and dataflow ). Under an FHE scheme, such as Cheon-Kim-Kim-Song (CKKS), significant challenges arise in determining both where to perform bootstrapping within a layer and how to use the limited “residual capacity” without incurring excessive memory or computational overhead.

Some embodiments address these challenges by leveraging the structure of ML operations within a model, potentially applying the same scheduling principles to each layer. For example, polynomial approximations for non-linear activations (e.g., ReLU or SoftMax), which can have higher multiplicative depth yet lower computational effort and dataflow, are classified as “deep-narrow” operations suited to higher Residue Number System (RNS) levels. By contrast, matrix multiplications or convolutions, which operate on higher computational effort and dataflow, but involve fewer sequential multiplications, may be performed at lower RNS levels. The disclosed subject matter also includes a feature referred to as “bootstrapped capacity borrowing,” whereby certain stages of the bootstrapping process (e.g., the S2C step) are shifted into a prior cycle, thus leaving additional levels available for subsequent operations.

In some cases, a single ML layer (e.g., a CNN layer or a transformer attention block) may involve multiple bootstraps due to substantial multiplicative depth. Data expansion can further increase the cost of bootstrapping, as more polynomials may need to be refreshed. Repeated bootstrapping can become a performance bottleneck if not applied judiciously. By determining the number, configuration (e.g., residual capacity, capacity borrowing, partial bootstrapping), and placement of bootstrapping within each layer, the embodiments described herein help mitigate unnecessary overhead and limit excessive computational or bandwidth costs. As no data-dependent branching occurs at runtime under FHE, these decisions are implemented at compile time to produce a deterministic bootstrapping schedule.

In some embodiments, bootstrapping can be configured on a per-layer or per-block basis. For example, bootstrapping may employ a standard full-capacity approach or a lower-capacity (residual-capacity-based) approach that raises ciphertexts only to the minimal required level. In addition, borrowing capacity from a previous cycle can reduce overhead in subsequent stages. This approach ensures that high-multiplicative-depth operations occur at sufficiently high levels, while shallow computations proceed more efficiently at lower levels. Scheduling decisions are therefore resolved during an offline optimization or compilation phase, rather than in real time.

These technical solutions address runtime overhead and resource consumption in homomorphic ML inference. By aligning the scheduling of bootstrapping with each stage’s specific requirements, polynomial approximations may be applied at higher levels while large-volume multiplications proceed at lower levels, thereby minimizing computational load and balancing dataflow and intermediate memory usage.. This approach mitigates the costs associated with data transfer, power consumption, and on-chip resource usage. Furthermore, the same approach may be repeated or iteratively optimized for each common layer structure, promoting consistent performance gains across the entire ML pipeline.

In some embodiments, the neural network architecture described herein may include branching structures, wherein one or more layers split into parallel sub-blocks that eventually merge at a subsequent stage. The scheduling methods described herein (e.g., selecting bootstrapping parameters, partial bootstrapping, or capacity borrowing) may also be applied in such branching scenarios. For example, each parallel branch may be assigned a suitable bootstrapping configuration, ensuring that each branch maintains an appropriate Residue Number System (RNS) level for its respective deep-narrow or shallow-wide computations. Upon merging, the ciphertexts may be resynchronized at a compatible RNS level, avoiding dataflow inconsistencies and preserving the performance gains of synchronized bootstrapping.

The disclosed embodiments can be applied to various FHE schemes, including, but not limited to, CKKS, Brakerski-Fan-Vercauteren (BFV), Brakerski-Gentry-Vaikuntanathan (BGV), and related approaches. By regulating the timing and capacity of bootstrapping on a layer-by-layer basis and synchronizing these choices across the model, the present subject matter supports more practical large-scale homomorphic computations.

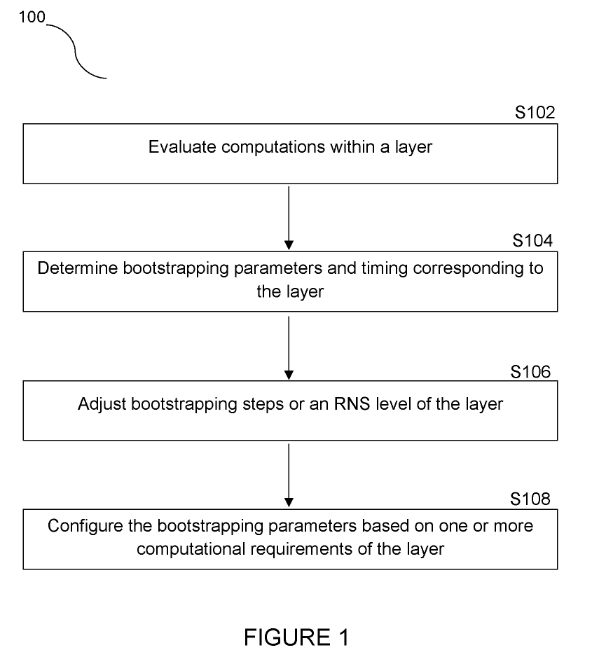

FIG. 1 is a flowchart 100 illustrating a method for managing RNS levels and bootstrapping in an encrypted machine learning environment, in accordance with an embodiment of the present disclosure.

In some embodiments, this method is performed by an FHE system (e.g., an accelerator, a server, or a specialized hardware processor) configured to carry out fully homomorphic encryption (FHE) operations. An example FHE system is discussed below.

In S102, the computations within a single ML layer are evaluated. This evaluation may involve receiving or retrieving descriptive information about the layer, including but not limited to the convolutional kernel layout, polynomial approximations for non-linear activations, or matrix dimensions for fully connected operations. Based on this information, deep-narrow operations may be distinguished (e.g., polynomial approximations with higher multiplicative depth but lower computational effort and dataflow ) from shallow-wide operations (e.g., convolutions or matrix multiplications that handle higher computational effort and dataflow but involve fewer sequential multiplications). In certain embodiments, points of data expansion may be detected, such as dimension growth in an attention mechanism (e.g., the Q*K multiplication). At this stage, each bootstrapping operation may be substantially expensive. Therefore, while it may be advantageous to enter a higher RNS level before a deep-narrow operation, doing so repeatedly may degrade overall performance. As such, example embodiments may adopt an iterative approach, systematically testing different bootstrapping schedules for total runtime.

It should be noted that by implementing S102, essential context may be acquired, including an anticipated multiplicative depth, a projected data volume, and potential noise accumulation, thereby preparing a framework for subsequent bootstrapping decisions. In some embodiments, the steps of FIG. 1 are performed during a compilation or optimization phase, during which these algorithm parameters are set before runtime. Accordingly, for example, if the convolution filter layout changes from a 3×3 to a 5×5 kernel or if the polynomial degree of an activation function is increased, a new compilation or optimization pass is performed to integrate these updates.

In S104, bootstrapping parameters and timing for the layer is determined. This determination may involve, specifying how many bootstraps may be required, wherein each required bootstrap may yield different residual capacity (i.e., how many levels remain for further multiplications after a bootstrapping event).In some embodiments, the minimal RNS level for initiating bootstrapping may be derived from broader FHE scheme parameters (e.g. required precision).Additionally, bootstrapping may be scheduled based on the order of upcoming operations, such that the bootstrapping cycle occurs immediately before a deep-narrow operation (e.g., a polynomial approximation) or is deferred until after a shallow-wide operation (e.g., a large convolution).

For example, if the analysis from S102 indicates that a polynomial approximation with considerable multiplicative depth is imminent, meaning it is scheduled to occur in the next stage or sub-block of the layer, bootstrapping may be scheduled immediately before that approximation. Conversely, if a wide convolution is expected, postpone bootstrapping may be postponed to avoid a substantial multiplication load at high RNS levels. In some implementations, these decisions are driven by heuristic rules or locally stored parameters within the FHE system. Examples for a heuristic rule may include relying on predefined thresholds for allowable noise growth, maximum data volume, or depth requirements, such that “if the upcoming operation exceeds a particular depth threshold, trigger bootstrapping prior to its execution,” or “if the upcoming operation involves more than a specified data volume, defer bootstrapping to reduce overhead.” In certain embodiments, bootstrapping sub-stages (e.g., Slots-to-Coefficients) may be re-ordered to occur earlier or later within the layer’s flow when the next operation requires additional capacity, thereby adjusting not just the fact of bootstrapping but also its precise timing relative to the sequence of computations.

In S106, the FHE system modifies bootstrapping steps or adjusts an RNS level based on the parameters from S104. For example, sub-stages of bootstrapping, such as shifting a Slots-to-Coefficients (S2C) step to an earlier cycle, may be re-ordered in order to carrying capacity forward into upcoming computations. This process, referred to as bootstrapped capacity borrowing, is particularly useful for deep-narrow operations that require additional levels. As another alternative, partial (or residual-capacity-optimized) bootstrapping may be applied, raising ciphertexts only to the minimal RNS level needed for the remaining operations in the layer or until the next bootstrapping event occurs. This technique avoids unnecessary overhead when the subsequent operations are relatively shallow. In another embodiment, the sub-stages remain in their original sequence and partial bootstrapping may be used instead for conserving resources. In one embodiment, the system may perform partial bootstrapping, in which the ciphertext is refreshed only to a level sufficient for imminent operations. This avoids the overhead of computations at high RNS levels.

In S108, bootstrapping depth may be synchronized with the layer’s computations computed offline during the compilation phase. For example, by aligning the RNS levels with scheduled operations executed during compilation, a high-depth polynomial approximation can follow closely after a bootstrapping refresh, thus benefiting from a full complement of levels, whereas shallow multiplication intensive operations are carried out at lower levels to reduce computational and bandwidth overhead. In some embodiments, a control table or scheduling structure is established during the compilation or optimization phase so that if data volume or noise levels deviate from initial estimates, a new compilation may be executed to revise the bootstrapping schedule. By performing S108, the method minimizes bottlenecks related to computational load and dataflow, avoids depleting RNS levels prematurely, and preserves efficient performance even when multiple bootstraps occur in a single layer.

In various embodiments, the optimized schedule derived from S108 may be applied to additional layers in the same neural model. By duplicating (or adapting) the approach for each identical or similarly structured layer, the process 100 achieves a consistent scheme for managing RNS levels and minimizing bootstrapping overhead at scale. In this manner, the performance gains realized in a single layer are replicated throughout the network (e.g., in convolutional or transformer-based architectures), preventing any layer-specific optimization from being isolated. Consequently, the overall model benefits from reduced computational load, balanced dataflow and memory usage, and improved overall performance. By contrast, a naïve approach might employ a single full-capacity bootstrapping configuration every time the system reaches its lowest RNS level, thereby using fewer bootstraps but incurring higher overhead and less flexibility throughout the computation. While examples herein reference Cheon-Kim-Kim-Song (CKKS), Brakerski-Fan-Vercauteren (BFV), and Brakerski-Gentry-Vaikuntanathan (BGV) schemes, the disclosed embodiments are not limited to those examples and may be applied in any FHE framework implementing bootstrapping for ciphertext refresh.

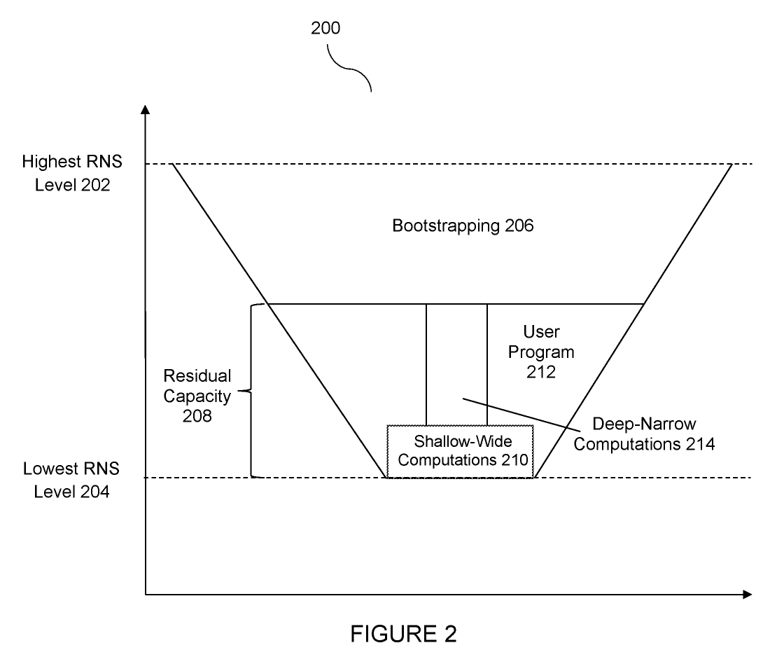

FIG. 2 is a conceptual diagram 200 illustrating RNS levels and bootstrapping considerations in an encrypted machine learning environment, in accordance with an embodiment of the present disclosure. As shown in FIG. 2, a vertical axis extends from the Highest RNS Level 202 at the top to the Lowest RNS Level 204 at the bottom, illustrating how ciphertexts can transition across different Residue Number System (RNS) levels under fully homomorphic encryption (FHE), such as CKKS, BFV, or BGV.

As shown in FIG. 2, a region labeled Bootstrapping 206 denotes the phase in which ciphertexts are refreshed to higher levels when noise accumulates or when greater multiplicative depth is required. Beneath this region, Residual Capacity 208 represents the number of RNS levels remaining after a bootstrapping event. By managing this capacity, the system can strategically schedule additional bootstrapping whenever ciphertexts approach the lower levels.

A user program 212 region is shown adjacent to (and coordinating) two distinct categories of computations: Shallow-Wide Computations 210 are depicted below, while Deep-Narrow Computations 214 lie to the right. In the illustrated embodiment, the user program 212 does not fall under either category; rather, it orchestrates or calls upon these separate computations. Shallow-wide computations 210 may involve greater computational overhead and data movement but fewer sequential multiplications (e.g., wide convolutional layers), and thus are more effectively handled at relatively lower RNS levels to minimize overhead. Deep-narrow computations 214, on the other hand, have greater multiplicative depth requirements (e.g., polynomial approximations of non-linear activations like ReLU or SoftMax) but process fewer inter-operand operations at each stage, making higher RNS levels more advantageous.

The funnel-like visualization of FIG. 2 is not drawn to scale but conveys how the FHE system may allocate different parts of an ML workload to suitable RNS levels. For example, after a bootstrapping event at Bootstrapping 206, the FHE system may execute deep-narrow computations 214 at the newly replenished high levels, then proceed to the lower levels for shallow-wide computations 210. In this manner, Residual Capacity 208 is consumed incrementally, and another bootstrapping may be triggered if the user program 212 requires additional multiplicative depth.

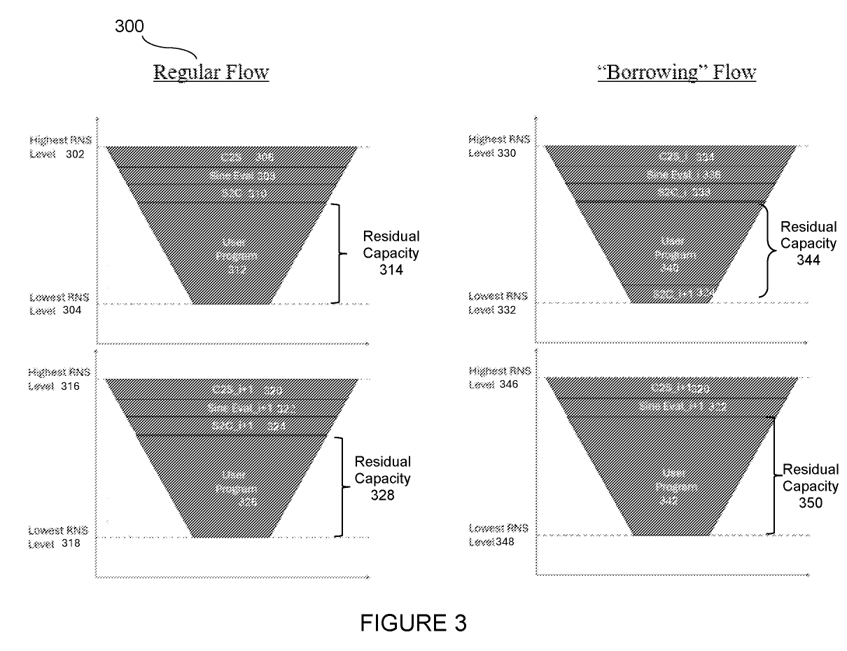

FIG. 3 is a conceptual diagram 300 comparing multiple bootstrapping sequences in an encrypted machine learning environment, in accordance with an embodiment of the present disclosure. Referring to FIG. 3, the diagram 300 contrasts a “Regular Flow” approach with a “Borrowing Flow” approach for performing bootstrapping. Each funnel depicts ciphertexts moving from a Highest RNS Level at the top to a Lowest RNS Level at the bottom, thereby illustrating how Residue Number System (RNS) levels are consumed during the bootstrapping process.

In some embodiments, the FHE system may shift the Slots-to-Coefficients (S2C) step from a later stage into the prior cycle. This selective relocation effectively “borrows” additional levels for the subsequent cycle, ensuring that an undesired bootstrapping event does not occur under conditions that would impose a heavy penalty, such as operating at high RNS levels or during significant data expansion.

In the upper-left funnel (“Regular Flow”), ciphertexts begin at Highest RNS Level 302 and progress downward to Lowest RNS Level 304, passing through C2S 306 ( Coefficients-to-Slots), Sine Eval 308 (a polynomial or sine-based modular reduction, and S2C 310 (Slots-to-Coefficients) . Below these stages, the region labeled User Program 312 corresponds to Residual Capacity 314, which represents the usable RNS levels remaining after S2C 310. These available levels may be allocated to deep-narrow or shallow-wide computations, depending on the requirements of user program 312. A similar sequence is shown in the lower-left funnel, where ciphertexts descend from the Highest RNS Level 316 to the Lowest RNS Level 318 via C2S i+1 320, Sine Eval i+1 322, and S2C i+1 324, culminating in User Program 326 and its corresponding Residual Capacity 328. Here, “i” and “i+1” denote consecutive bootstrapping cycles, i.e., sub-stages labeled “i+1” occur in the cycle immediately after cycle “i.” Likewise, “j” and “j+1” may be used to indicate consecutive sub-blocks or steps within a single cycle.

In the upper-right funnel (“Borrowing Flow”), ciphertexts begin at Highest RNS Level 330 and proceed downward through C2S i 334 and Sine Eval i 336, ultimately arriving at S2C i 338. After this stage, the figure shows a User Program 340 and an S2C i+1 324 near the bottom of the funnel, collectively forming Residual Capacity 344. In the lower-right funnel, the ciphertext begins at Highest RNS Level 346 and proceeds down to Lowest RNS Level 348 by undergoing C2S i+1 320 and Sine Eval i+1 322. The resulting User Program 342 equates to Residual Capacity 350 and uses a larger portion of the levels than the user program 326 in the Regular Flow. The S2C i+1 324 step for this cycle is deferred to a prior or subsequent point enabling user program 342 to retain more levels than in the regular flow scenario.

The standard bootstrapping flow includes Mod-Raise (not shown explicitly), followed by C2S, Sine-Evaluation, and S2C in each cycle. Residual capacity refers to any remaining usable levels after S2C is completed. In various embodiments, the FHE system identifies a need for extra depth, the S2C stage for the upcoming cycle can be moved earlier (or later), effectively “borrowing” RNS levels. By placing S2C at the end of the previous cycle or shifting it beyond the user program, the ciphertext retains more levels for potentially deeper computational sequences. FIG. 3 provides a side-by-side comparison: the Regular Flow funnels keep C2S → Sine Eval → S2C in a fixed sequence, whereas the Borrowing Flow selectively reorders S2C (e.g., S2C i+1 324 in another funnel) to yield a larger Residual Capacity 350 for the user program’s computations.

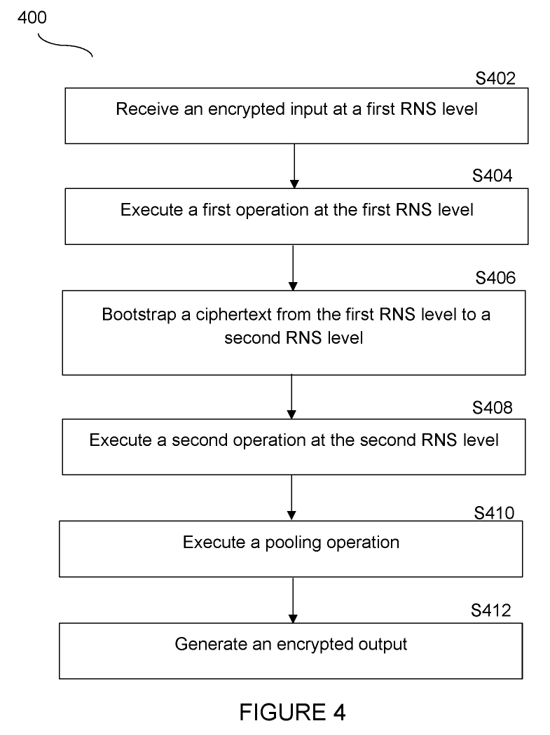

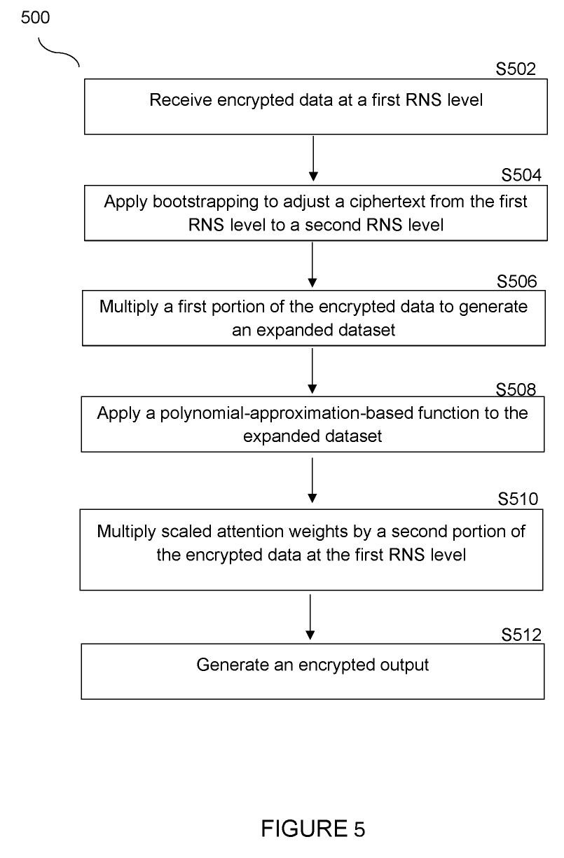

Although FIGS. 4 and 5 below illustrate exemplary strategies (such as positioning a bootstrapping event near polynomial approximations) these approaches do not necessarily yield a globally optimal result for all applications. Rather, an offline or compile-time process may be employed to analyze multiple scheduling schemes, including different bootstrap capacities, partial bootstrapping and capacity borrowing, to identify a suitable tradeoff between overhead and computational depth. The examples presented herein, such as those involving convolutional neural networks (CNNs) and large language models (LLMs), are consequently provided as illustrative rather than definitive solutions. Moreover, since fully homomorphic encryption (FHE) does not permit real-time data-dependent branching, these determinations are generally made prior to runtime.

For the examples illustrated below in FIGS. 4 and 5, the terms “first level,” “second level,” and similar terminology refer to a stage of processing rather than to a specific numerical residual-level value. For example, the term “first level” refers to the initial stage of processing and may correspond to the lowest RNS level immediately before bootstrapping, the highest RNS level immediately after bootstrapping, or any other residual level. These terms identify the level at which a given computation begins and are not intended to specify, or imply, the multiplicative depth of that computation.

FIG. 4 is a flowchart 400 illustrating a method, executed by a compiler or optimizer, for generating a neural network program that implements managing RNS levels and bootstrapping, in accordance with an embodiment of the present disclosure. In some embodiments, this compiler or optimizer is integrated with (or used by) an FHE system configured to execute encrypted CNN inference under a fully homomorphic encryption (FHE) scheme (e.g., CKKS, BFV, or BGV). The flowchart 400 describes how RNS levels are managed within the neural network layer, e.g. a convolutional neural network (CNN), to align with the RNS-level management approach described in FIG. 1.

In S402, an encrypted input at a first RNS level is received. This encrypted input may correspond to feature maps output by a prior CNN layer or an initial encrypted image. In certain implementations, these feature maps from on-chip memory or over a network interface may be retrieved, triggering a data transfer whenever the previous layer completes its operations. In one example, the first RNS level is chosen to be “low” (i.e., fewer RNS residues) to reduce overhead for wide data-movement operations. By keeping the RNS level low, potentially large feature-map dimensions characteristic of CNNs is processed more efficiently

In S404, a first operation at the first RNS level is executed. For example, in a CNN context, this “first operation” may be a convolution step, which multiplies each pixel or feature-map element by a small mask (e.g., a 3×3 or 5×5 kernel). Convolution is relatively “shallow-wide” (i.e., many parallel multiplications with low sequential depth), so performing convolution at a lower RNS level helps minimize computational load and balance dataflow and intermediate memory usage. For example, if the convolution mask size is 3×3, each pixel in the feature map is multiplied by nine coefficients; at a lower RNS level, the multiplication overhead and the data expansion is reduced, improving efficiency. Alternately, if the layer uses multiple convolutional kernels in parallel (such as different feature-detection filters), the same lower RNS level can still be leveraged to process them without incurring a large computational, dataflow, and memory overhead.

In S406, a ciphertext is bootstrapped from the first RNS level to a second (e.g. higher) RNS level. This timing is strategically placed after the convolution is completed. By delaying bootstrapping until after the wide, parallel multiplications have finished, raising the ciphertext to a high RNS level prematurely is avoided, thus reducing overhead from large data volumes. In the example CNN, the second RNS level is chosen to be “higher” so that there is sufficient multiplicative depth available for the subsequent non-linear activation. In one embodiment, the required number of sequential multiplications for the next layer segment is determined, and a bootstrapping level that precisely accommodates that depth is selected, thereby conserving resources.

In S408, a second operation at the second RNS level is executed. In the context of CNNs, this second operation is typically a non-linear activation function (e.g., ReLU), implemented via a polynomial approximation under FHE. ReLU approximations often require more sequential multiplications (i.e., a greater multiplicative depth) but fewer multiplications overall. Consequently, carrying out the multiplications at a replenished or higher RNS level (“deep-narrow”) helps manage high multiplication costs. If the activation polynomial has multiple terms or a higher degree, the additional homomorphic capacity ensures the necessary sequential multiplications can be performed without prompting another immediate bootstrap.

At S410, an average pooling operation at an available RNS level is executed following the execution of the second operation (e.g. ReLU polynomial approximation). In many CNN architectures, average pooling or max-pooling follows the activation step. Average pooling by itself is not especially multiplication-intensive and does not severely consume homomorphic levels. However, performing average pooling at this stage takes advantage of the still-available level capacity after the ReLU polynomial approximation and ensures that intermediate feature maps can be down-sampled or aggregated without forcing another bootstrap.

At S412, an encrypted output is generated. This encrypted output may correspond to the transformed (convolved, activated, and pooled) feature maps, ready either for another convolution cycle in the same CNN or for subsequent layers. Generally, if the next layer operates at a lower RNS level, it is more efficient to reduce the level at the start of the computation (e.g. at S402 or S404) or employ partial‐capacity bootstrapping earlier. However, if those earlier steps were not taken, the output can still be reverted or reduced to the lower RNS level at this stage, ensuring layer‐by‐layer synchronization. For example, if the next layer also implements a wide convolution first, the system can downshift the ciphertext to a lower RNS level to maintain optimal efficiency at the next step.

As illustrated in FIG. 4, the bootstrapping action at S406 is placed just before the “deep-narrow” ReLU approximation operation at S408 rather than before the “shallow-wide” convolution at S404. By strategically bootstrapping in this way, the flow of FIG. 4 significantly reduces overhead from high volume of multiplications and large data volumes at high RNS levels. In turn, it minimizes computational cost and memory bandwidth requirements for both the ciphertext data and the model coefficients. This arrangement ensures that the highest RNS levels are reserved for non-linear operations requiring less multiplication overhead but additional multiplicative depth, while the more multiplication-intensive and bandwidth-intensive convolution occurs at a lower level. In more involved use cases, a single layer may contain multiple bootstraps, or partial bootstrapping methods may be combined, subject to an offline optimization process that balances overall cost.

In some embodiments, a basic CNN layer may suffice with one bootstrap interval per layer, whereas more complex transformer-based layers (e.g., multi-head attention in GPT-like models) may require multiple bootstraps in a single layer to handle polynomial-based operations such as SoftMax approximation.

FIG. 5 is a flowchart 500 illustrating a method executed by an attention-based architecture that implements the method of FIG. 1, in accordance with an embodiment of the present disclosure. In some embodiments, the method of FIG. 5 is performed by a dedicated FHE system configured to run large language model (LLM) workloads in an encrypted domain. The system may communicate with external storage or networked devices to retrieve encrypted token embeddings or intermediate feature vectors. These vectors can be processed by multi-head attention and feed-forward blocks, which are common in GPT-like transformer models containing repeated attention layers.

At S502, encrypted data at a first RNS level is received. In a transformer-based model, this encrypted data can represent token embeddings or partial attention matrices. In conventional approaches, this data is supplied at the highest RNS level to maximize computational capacity at the beginning of the pipeline. In some embodiments described herein, if an analysis of the planned bootstrapping schedule indicates that no additional capacity is needed initially, the data may instead be provided at a lower RNS level, thereby reducing bandwidth and memory usage. For example, token embeddings or partial attention matrices can be retrieved from a remote device or local memory and loaded into the FHE pipeline, depending on how multi‐head attention blocks are partitioned.

At S504, bootstrapping is applied to adjust the ciphertext from the first RNS level to a second RNS level. For example, the “Q×K” multiplication in an attention block exemplifies a “wide‐shallow” operation: it may involve large matrices with numerous parallel multiplications but does not inherently consume additional levels (since it lacks sequential multiplication chains). Consequently, performing a bootstrap before Q×K may prevent overhead from data expansion if the ciphertext is already at a high RNS level. In some implementations, it may instead be preferable to conduct Q×K at a lower RNS level from the outset, depending on subsequent transformer layers or feed‐forward blocks that might require higher capacity (e.g., for polynomial approximations). In some embodiments, scheduling of bootstraps may be determined by an offline or compile‐time process that balances capacity, noise, and data movement constraints across the entire LLM pipeline.

At S506, a first portion of the encrypted data is multiplied to generate an expanded dataset. For example, in a GPT-like model, this first portion of the encrypted data may correspond to the “Q” (query) and “K” (key) matrices. When Q is multiplied by K, the resultant matrix can expand the dimension (e.g., from 1× to 16×) on a per attention head or immediate channel basis rather than strictly following the total number of heads. In some embodiments, each multiplication consumes one RNS level, and additions are negligible, so Q×K does not span multiple levels despite the dimension expansion. If S504 included a bootstrap, then sufficient capacity may remain at this step. Whether an additional re-bootstrap is required may depend on the overall scheduling of homomorphic operations in subsequent steps (e.g., SoftMax approximation or feed-forward stages).

At S508, a polynomial-approximation-based function is applied to the expanded dataset. For example, in an attention mechanism, this polynomial-approximation-based function can be the SoftMax approximation, which is non-linear and typically requires multiple multiplicative steps. SoftMax approximation is considered a “deep-narrow” operation because, while it might be applied to fewer elements than a large matrix multiplication, its sequential polynomial depth can be significant. Consequently, carrying out these multiplications at a replenished or higher RNS level helps manage high multiplication costs. If the polynomial-approximation-based function has multiple terms or a higher degree, the additional homomorphic capacity ensures the necessary sequential multiplications can be performed without prompting another immediate bootstrap.

At S510, scaled attention weights resulting from the Q×K multiplication and subsequent SoftMax approximation are multiplied by a second portion of the encrypted data. In some embodiments, this second portion corresponds to the “V” (value) matrix in a multi‐head attention block, where the V matrix contains the actual content or values to be weighted by the attention mechanism. In some embodiments, this computation may represent the final part of the attention block, where the computed weights are combined with the actual value data.. Since this operation often involves large data arrays but fewer sequential multiplications, this operation can be considered shallow-wide and thus well-suited to the lower RNS level. The result is typically an attention-weighted matrix whose dimensions revert to the original token embedding size. For example, the multiplication typically restores the matrix from its expanded dimension (e.g., 16×) back to the original token embedding size (e.g., 1×). If future layers or feed-forward blocks do not require deep polynomial capacity, the ciphertext simply resides at this lower level. Otherwise, another bootstrap may be scheduled (partial or full) if there is a subsequent deep-narrow stage.

At S512, the system generates an encrypted output. This output may correspond to the updated token embeddings or attention results that feed into subsequent transformer layers or MLP blocks. If additional layers require further polynomial-based activations or expansions, the system can again selectively bootstrap at appropriate points, maintaining an optimal balance between deep-narrow steps (e.g., SoftMax or other approximations) and shallow-wide steps (e.g., matrix multiplications at expanded dimensions).

By orchestrating bootstrapping around the key multiplications (Q×K, SoftMax approximation, and then V multiplication), the method of FIG. 5 ensures that high RNS levels are used only when deep polynomial depth is necessary. As a result, this approach avoids incurring large computational costs and large data volumes at high RNS levels and efficiently handles dimension expansion in the attention mechanism.

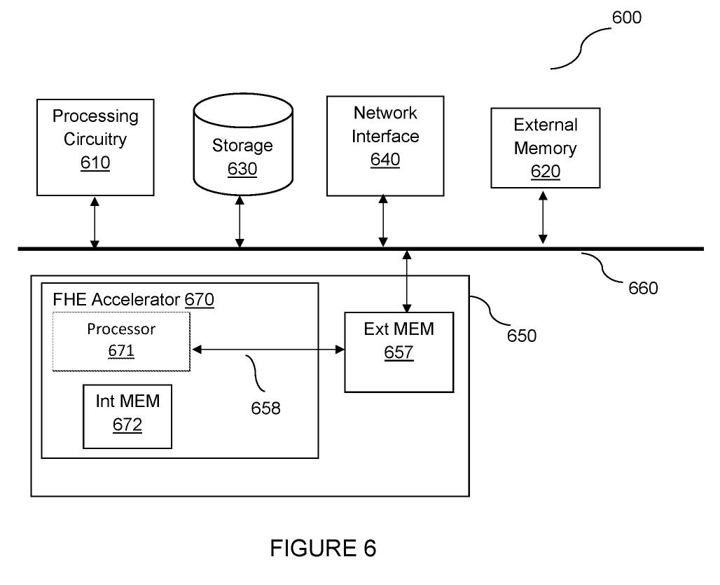

FIG. 6 is a block diagram of an FHE system 600 incorporating a fully homomorphic encryption (FHE) accelerator 670, in accordance with various embodiments of the present disclosure. In some embodiments, the FHE system 600 may be implemented as a server. The FHE system 600 includes a processing circuitry 610 coupled to a memory 620, a storage 630, a network interface 640, and an FHE card 650. In one embodiment, the components of the FHE system 600 may be communicatively connected via bus 660. The processing circuitry 610 may be realized as one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip (SoC) systems, graphics processing units (GPUs), tensor processing units (TPUs), general-purpose microprocessors, microcontrollers, digital signal processors (DSPs), and the like, or any other hardware logic components capable of performing calculations or other manipulations of information.

External Memory 620 may be volatile (e.g., random access memory), non-volatile (e.g., read-only memory, flash memory), or a combination thereof, and serves as the main system memory for FHE system 600. This is distinct from the external memory 657 on the FHE card 650, which is specifically dedicated to supporting FHE operations. Storage 630 may include non-volatile memory devices, magnetic disk drives, optical disk drives, tape drives, and similar devices. Examples of memory 620 may include EEPROM, ROM, PROM, RAM, DRAM, SRAM, flash memory, firmware, programmable logic, and so on. Storage 630 may comprise internal storage, attached storage, and/or network-accessible storage. In some embodiments, memory 620 or storage 630 may also store compiler or optimizer software that processes neural network definitions to produce compiled FHE inference plans. During compilation, bootstrapping and RNS-level scheduling are determined in accordance with the methods described herein, and the resulting optimized instructions or schedules are then executed by the FHE system 600 at runtime. The network interface 640 allows FHE system 600 to communicate with external systems, utilizing various communication protocols.

Memory 620 and/or storage 630 may store software required to execute homomorphic encryption operations in accordance with the single-layer bootstrapping and depth-management methods described herein. The bus 660 may include, for example, a PCIe bus.

Software should be construed broadly to include any type of instructions, whether referred to as software, firmware, middleware, microcode, hardware description language, or otherwise. Instructions may include code in various formats, such as source code, binary code, executable code, or any other suitable format.

FHE card 650 is configured to rapidly perform complex homomorphic operations. The FHE card 650 can be installed in FHE system 600 or operate as a standalone device. The FHE card 650 includes an FHE accelerator 670.

The FHE accelerator 670 includes a processor 671 and an internal memory 672, or multiple processors with internal memory, designed to accelerate homomorphic encryption operations required for single-layer bootstrapping, depth management, capacity borrowing, and other homomorphic machine-learning tasks. Processor 671 may include multiple cores capable of managing multiple computation threads simultaneously. Internal memory 672 is dedicated to storing data for executing homomorphic encryption operations, including encrypted model data and intermediate results related to polynomial evaluations, bootstrapping steps, and layer-by-layer computations. Internal memory 672 is designed for high bandwidth, enabling quick access to stored data. It is realized as on-die memory.

In one embodiment, the FHE accelerator 670 can be realized as an ASIC. In other embodiments, the FHE accelerator 670 can be realized as an FPGA, ASSP, SoC, or other hardware logic components capable of performing calculations or other manipulations of information. The FHE card 650 also includes external memory 657 and a memory bus 658. Memory bus 658 can be configured as a dedicated high-speed interface through which processor 671 communicates with external memory 657, enabling efficient data transfer when performing the encryption-level management flows. Typically, external memory 657 is an SDRAM, high-bandwidth SDRAM (e.g., GDDR5, GDDR6), or high-bandwidth memory (HBM).

The FHE card 650 connects to the server's main components through bus 660 via a dedicated interface. This interface, typically implemented as PCIe, enables high-speed communication between the FHE card 650 and other server components such as processing circuitry 610 and external memory 620.

The FHE accelerator 670 is particularly suited for the computational demands of single-layer bootstrapping and encryption-level synchronization. It can operate in real-time or batch modes to carry out polynomial approximations, matrix multiplications, partial bootstrapping, and borrowing flow operations aligned with the invention’s deep-narrow and shallow-wide principles. The accelerator's architecture supports the processing requirements of both local and cloud-based deployments, including multiple homomorphic layers or multi-head attention blocks.

While the disclosed techniques primarily address inference in FHE-based machine-learning systems, they can also be adapted for training workflows under homomorphic encryption. Training often involves a higher volume of multiplications and more frequent bootstrapping, but the core single-layer optimization principles—such as aligning deep-narrow and shallow-wide operations and managing noise accumulation—remain applicable, subject to available hardware resources and noise-management constraints. It should be understood that the embodiments described herein are not limited to the specific architecture illustrated in FIG. 6, and other architectures may be used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A computer-implemented method for managing bootstrapping in an encrypted attention-based architecture, the method comprising:
receiving encrypted data at a first Residue Number System (RNS) level;
applying bootstrapping to adjust a ciphertext from the first RNS level to a second RNS level;
multiplying a first portion of the encrypted data to generate an expanded dataset;
applying a polynomial-approximation-based function to the expanded dataset;
multiplying scaled attention weights by a second portion of the encrypted data at the first RNS level; and
generating an encrypted output.

2. The method of claim 1, wherein the first portion of the encrypted data comprises a plurality of query and key matrices of an attention block.

3. The method of claim 1, wherein the polynomial-approximation-based function is a polynomial approximation of a SoftMax function.

4. The method of claim 1, wherein the second portion of the encrypted data comprises a value matrix in an attention block.

5. The method of claim 1, wherein the multiplication of scaled attention weights by the second portion of the encrypted data is executed at the first RNS level to reduce computational overhead for shallow-wide operations.

6. The method of claim 1, further comprising repeating the steps of multiplying the first portion of the encrypted data and applying the polynomial-approximation-based function for each attention head of a plurality of attention heads in a multi-head attention architecture.

7. The method of claim 1, further comprising scheduling of the bootstrapping based on an offline or compile-time process that balances capacity, noise, and data movement constraints.

8. The method of claim 1, wherein the multiplication of the first portion produces an expanded dataset from one dimension to a larger dimension on a per attention head basis.

9. The method of claim 1, wherein the multiplication of the first portion of the encrypted data is a shallow-wide operation, the polynomial-approximation-based function is a deep-narrow operation, and the multiplication of scaled attention weights by the second portion of the encrypted data is a shallow-wide operation.

10. The method of claim 1, further comprising providing the encrypted output as updated token embeddings to at least one subsequent transformer layer or feed-forward block.

11. A non-transitory computer-readable medium storing a set of instructions for managing bootstrapping in an encrypted attention-based architecture, the set of instructions comprising:
one or more instructions that, when executed by one or more processors of a device, cause the device to:
receive encrypted data at a first Residue Number System (RNS) level;
apply bootstrapping to adjust a ciphertext from the first RNS level to a second RNS level;
multiply a first portion of the encrypted data to generate an expanded dataset;
apply a polynomial-approximation-based function to the expanded dataset;
multiply scaled attention weights by a second portion of the encrypted data at the first RNS level; and
generate an encrypted output.

12. A system for managing bootstrapping in an encrypted attention-based architecture comprising:
a processing circuitry;
a memory, the memory containing instructions that, when executed by the processing circuitry, configure the system to:
receive encrypted data at a first Residue Number System (RNS) level;
apply bootstrapping to adjust a ciphertext from the first RNS level to a second RNS level;
multiply a first portion of the encrypted data to generate an expanded dataset;
apply a polynomial-approximation-based function to the expanded dataset;
multiply scaled attention weights by a second portion of the encrypted data at the first RNS level; and
generate an encrypted output.

13. The system of claim 12, wherein the first portion of the encrypted data comprises a plurality of query and key matrices of an attention block.

14. The system of claim 12, wherein the polynomial-approximation-based function is a polynomial approximation of a SoftMax function.

15. The system of claim 12, wherein the second portion of the encrypted data comprises a value matrix in an attention block.

16. The system of claim 12, wherein the multiplication of scaled attention weights by the second portion of the encrypted data is executed at the first RNS level to reduce computational overhead for shallow-wide operations.

17. The system of claim 12, wherein the memory contains further instructions which when executed by the processing circuitry further configure the system to:
repeat the steps of multiplying the first portion of the encrypted data and applying the polynomial-approximation-based function for each attention head of a plurality of attention heads in a multi-head attention architecture.

18. The system of claim 12, wherein the memory contains further instructions which when executed by the processing circuitry further configure the system to:
schedule of the bootstrapping based on an offline or compile-time process that balances capacity, noise, and data movement constraints.

19. The system of claim 12, wherein the multiplication of the first portion produces an expanded dataset from one dimension to a larger dimension on a per attention head basis.

20. The system of claim 12, wherein the multiplication of the first portion of the encrypted data is a shallow-wide operation, the polynomial-approximation-based function is a deep-narrow operation, and the multiplication of scaled attention weights by the second portion of the encrypted data is a shallow-wide operation.

21. The system of claim 12, wherein the memory contains further instructions which when executed by the processing circuitry further configure the system to: provide the encrypted output as updated token embeddings to at least one subsequent transformer layer or feed-forward block.
